(19) United States
(12) Patent Application Publication
(10) Pub. No.: US 2012/0255903 A1
(43) Pub. Date: Oct. 11, 2012

(54) NON-WOVEN MEMBRANE BIOREACTOR AND ITS FOULING CONTROL METHOD

(76) Inventors: Steven DuWayne Kloos, Minnetonka, MN (US); Sijing Wang, Shanghai (CN)

(21) Appl. No.: 12/988,814

(22) PCT Filed: Dec. 30, 2009
(86) PCT No.: PCT/CN09/01581

§ 371 Date: Oct. 21, 2010

(51) Int. Cl. C02F 9/14

(52) U.S. Cl. 210/608

(57) ABSTRACT

Disclosed is a method for biological treatment of wastewater in a non-woven membrane bioreactor (MBR) system. The mixed liquor contained in the bioreactor is filtered with a non-woven fabric membrane having a pore size in the range of 0.1 μm to 5.0 μm. Membrane fouling is controlled and flux is improved in the non-woven MBR system by adding an effective amount of a water soluble sludge filterability improvement chemical to the mixed liquor.

### CROSS-REFERENCE TO RELATED APPLICATIONS

This application claims priority under 35 U.S.C. §119(a)-(d) or (f) to prior-filed, co-pending Chinese application number CN09/01581, filed on Jul. 30, 2009, which is hereby incorporated by reference in its entirety.

### BACKGROUND OF THE INVENTION

1. Field of the Invention

This invention relates generally to membrane bioreactor (MBR) systems, and particularly to a non-woven fabric membrane filtration module disposed therein and methods for conditioning microbial mixed liquor to improve flux in the membrane bioreactor.

2. Description of Related Art

Biological treatment of wastewater for removal of dissolved organics is well known and is widely practiced in both municipal and industrial plants. One form of treatment generally known as the “activated sludge” process uses micro-organisms to consume organic compounds through their growth and metabolism. The process necessarily includes sedimentation of the micro-organisms or “biomass” to separate it from the water and complete the process of reducing Biological Oxygen Demand (BOD) and TSS (Total Suspended Solids) in the final effluent. The sedimentation step is typically done in a clarifier unit. Thus, the biological process is constrained by the need to produce biomass that has good settling properties. This process can be especially difficult to maintain during intermittent periods of high organic loading and the appearance of contaminants that are toxic to the biomass and results in the generation of a considerable amount of excess sludge that must be disposed of. The expense for the excess sludge treatment has been estimated at 40 to 60 percent of the total expense of a wastewater treatment plant.

In membrane bioreactor (MBR) systems, influent wastewater is pumped or gravity flowed into a bioreactor tank where it is brought into contact with the microorganisms which biodegrade organic material in the wastewater. In these systems, ultrafiltration (UF), microfiltration (MF), or nanofiltration (NF) membranes replace sedimentation of biomass for solids-liquid separation. Aeration means such as blowers provide oxygen to the biomass. The resulting mixed liquor contained in the bioreactor is filtered through membranes under pressure or is drawn through the membrane under vacuum. The membrane may be immersed in the bioreactor tank or contained in a separate membrane tank to which wastewater is continuously pumped from the bioreactor tank. Clarified water is discharged from the system with much lower total suspended solids (TSS), typically less than 5 mg/L, compared to 20 to 50 mg/L from a clarifier, and excess activated sludge is pumped out of the bioreactor tank into a sludge holding tank in order to maintain a constant sludge age (SRT). The filtration membrane is regularly cleaned by backwashing, chemical washing, or both. Membrane biological reactors (MBR) de-couple the biological process from the need to settle the biomass, since the membrane sieves the biomass from the water.

However, the cost of UF/MF/NF type micro-porous membranes substantially influences the feasibility of MBR systems. In order to reduce the capital cost of the MBR process, attempts have been made to use a non-woven fabric material having a substantially lower manufacturing cost. Most non-woven fabrics used in the non-woven MBR system have an average pore size of 10-100 mm to obtain a high flux rate.

Because of this much larger pore size, the effluent water quality largely depends on the formation of a dynamic filtration layer on the non-woven fabrics membrane surface, which in turn greatly reduces the membrane flux rate. Membrane fouling can be attributed to surface deposition of suspended or dissolved substances. An MBR membrane interfaces with the biomass which contains aggregates of bacteria or “flocs”, free bacteria, protozoan, and various dissolved microbial products (SMP). The term SMP has been adopted to define the organic compounds that are released into the bulk microbial mixed liquor from substrate metabolism (usually biomass growth) and biomass decay.

In operation, the colloidal solids and SMP have the potential of depositing on the surface of the membrane. Colloidal particles form layers on the surface of the membrane, called a “cake layer.” MBR processes are designed to use rising coarse air bubbles to provide a turbulent cross flow velocity over the surface of the membrane. This process helps to maintain the flux through the membrane, by reducing the buildup of a cake layer at the membrane surface.

Another major drawback of the non-woven MBR system is that it is subjected to more severe fouling due to internal pore plugging by microbial sludge floc particles. Compared to a conventional activated sludge process, floc (particle) size is reportedly much smaller in typical MBR units. Small particles can plug the membrane pores, a fouling condition that may not be reversible. Pore plugging increases membrane resistance and decreases membrane flux. The pore plugging in non-woven MBR systems can be so sever that despite having higher inherent membrane permeability compared to conventional membranes used for MBR, the actual process fluxes of the non-woven media MBR systems in operation are typically less than half the flux rates of traditional polymeric MBR systems.

In addition to common membrane fouling control methods practiced in the ordinary MBR system including air scouring, backwashing and chemical cleaning, attempts have been made to add chemicals to the mixed liquor in the MBR system to condition the mixed liquor and enhance the filterability of the non-woven fabrics membrane. These filterability improvement chemicals serve to coagulate and flocculate the activated sludge and thereby to bind colloids and other mixed liquor components in flocs. Options include use of inorganic coagulants such as ferric and aluminum salts and aluminum polymers, powdered activated carbon (PAC) and other type of inert particles (e.g., resins), and water soluble polymers. Use of inorganic coagulants will increase sludge generation and are only applicable to a narrow pH range. Addition of powdered activated carbon to MBR systems will not only increase sludge concentration, it may also cause irreversible permeability loss due to membrane pore plugging by PAC, and membrane wear due to the abrasiveness of the PAC. These problems will exaggerate and additional fouling may develop when the added PAC concentration becomes higher (e.g., 600 mg/L or above).

Accordingly, a need exists to improve microbial mixed liquor filterability and enhance membrane flux while limiting pore plugging and fouling in non-woven MBR systems

### SUMMARY OF THE INVENTION

In one aspect, disclosed is a method for biological treatment of wastewater in a non-woven membrane bioreactor (MBR) system. The mixed liquor contained in the bioreactor is filtered with a non-woven fabric membrane having a pore size in the range of 0.1 μm to 5.0 μm. Membrane fouling is controlled and flux is improved in the non-woven MBR system by adding an effective amount of a water soluble sludge filterability improvement chemical to the mixed liquor.

The present invention and its advantages over the prior art will become apparent upon reading the following detailed description and the appended claims with reference to the accompanying drawings.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic of a typical example of an MBR in accordance with an embodiment of the invention.

### DETAILED DESCRIPTION OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

The singular forms “a,” “an” and “the” include plural referents unless the context clearly dictates otherwise.

“MBR” means membrane bioreactor or membrane biological reactor.

“Mixed liquor” or “activated sludge” means a mixture of wastewater, microorganisms used to degrade organic materials in the wastewater, organic-containing material derived from cellular species, cellular by-products and/or waste products, or cellular debris. Mixed liquor can also contain colloidal and particulate material (i.e., biomass/biosolids) and/or soluble molecules or biopolymers (i.e. polysaccharides, proteins, etc.).

“Mixed liquor suspended solids” (“MLSS”) means the concentration of biomass which is treating organic material, in the mixed liquor.

“Excess activated sludge” refers to the activated sludge that is continuously pumped from the bioreactor in order to maintain a constant sludge age in the bioreactor.

DADMAC is diallyldimethyl ammonium chloride; DMAEA/MCQ is dimethylaminoethylacrylate methyl chloride quaternary salt; DMAEA/BCQ is dimethylaminoethylacrylate benzyl chloride quaternary salt; DMAEM/MCQ is dimethylaminoethylmethacrylate methyl chloride quaternary salt; and DMAEM/BCQ is dimethylaminoethylmethacrylate benzyl chloride quaternary salt.

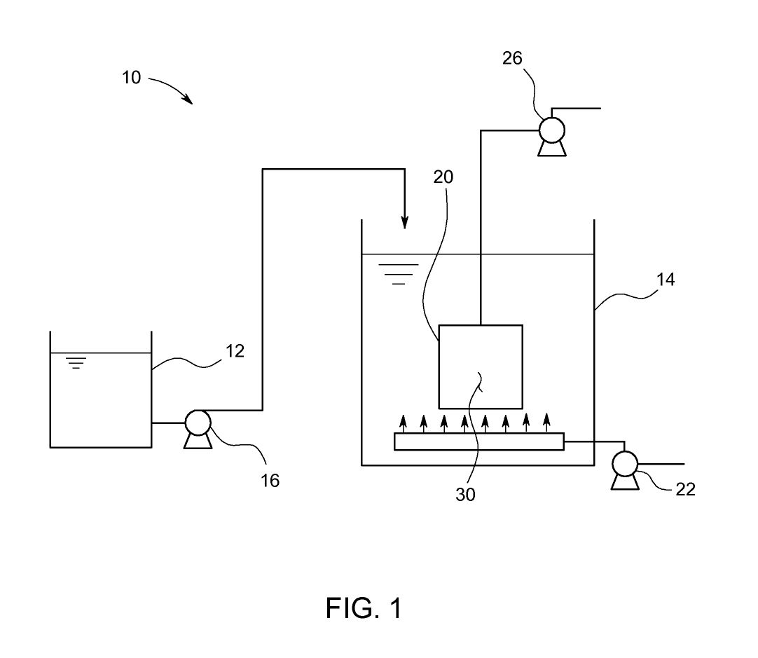

FIG. 1 is a block diagram of a membrane bioreactor (MBR) system 10 used for the treatment of domestic wastewater, industrial wastewater, farming wastewater, nitrogen removal from water or waste water, or other wastewater recovery. The wastewater to be treated is pumped from inlet water tank 12 into a membrane bioreactor tank 14 with water pump 16. The wastewater may be pretreated to remove coarse solids, suspended solids, and various fiber materials before entering the MBR system 10. A filtration module 20 is immersed in the mixed liquor in the membrane tank 14. As is known in the art, air may be pumped into the bottom of the membrane tank 14 using blower 22 to provide oxygen required by the MBR system 10. Permeate is discharged by an outlet pump 26. Membrane filtrate is separated from the activated sludge and exits the membrane. The activated sludge from membrane tank 14 is recycled to either an anoxic tank or an aerobic tank (not shown). A portion of activated sludge from the membrane tank is desirably drawn out for disposal in order to maintain an appropriate sludge retention time (SRT) in the MBR. The MBR system 10 may be comprised of a combination of anaerobic reactors, anoxic reactors, and aerobic reactors as is known in the art. A simplified MBR system 10 may be comprised of just one aerobic tank and the membrane module is submersed in the aerobic tank. Alternatively, the MBR system 10 may comprise one or more aerobic reactors, one or more anaerobic digesters, or a combination of one or more anaerobic digesters and one or more aerobic reactors.

In one embodiment, the filtration module 20 is constructed by wrapping a hydrophilic non-woven fabric membrane 30 having a suitable thickness and pore size on a porous support having a hollow tubular shape, e.g., a hollow tubular non-woven filter core. The non-woven fabric membrane 30 comes into contact with wastewater to be treated. In one embodiment, the filtration module 20 has a central passage; and a pump (not shown in the figure) is used to generate suction in the central passage. Thus, the wastewater to be treated penetrates through the non-woven fabric membrane 30 and becomes permeate in the central passage. Since the non-woven fabric membrane 30 on the outer layer has a lower cost, it can be replaced for restoring a larger permeate flux when the flux becomes too low.

The thickness and the pore size of the non-woven fabric membrane can be determined by the required operating flux and other needs. The binding of the non-woven fabric membrane and the support can be done by using a hot-melt resin adhesion, an adhesive adhesion or other appropriate adhesions. Desirably, the binding area between the two must be large enough to provide a sufficient strength for performing a back washing operation. The thickness of the non-woven fabric membrane 30 is preferably maintained at less than 2 mm so that the fouling is easy to be removed during a back washing operation.

The non-woven fabric membrane 30 has a narrow and small pore size range, which is preferentially in the range of 0.1 μm to 5.0 μm, and more preferably in the range of 0.2 μm to 3.0 μm to ensure the water quality of the membrane filtrate. The non-woven membrane 30 is desirably prepared by either coating a hydrophilic polymer layer on a non-woven fabric membrane or grafting a hydrophilic monomer, such as an acrylic acid or its derivatives, or another polymerizable hydrophilic monomer, onto a non-woven fabric membrane by a grafting polymerization process.

Common membrane fouling control methods may be used with the MBR system 10 including air scouring, backwashing and chemical cleaning In addition, one or more filterability improvement chemicals are dosed to the mixed liquor of the MBR system 10 and serve to coagulate and flocculate the activated sludge and thereby to bind colloids and other mixed liquor components in flocs. With formation of larger flocs, the average particle size is significantly increased, which reduce/minimize the internal pore plugging in the non-woven membrane 30. The filterability improvement chemicals can not only have a positive impact to decrease soluble foulants in the mixed liquor and also improve the hydraulic permeability of the cake formed on the surface of the membrane 30. In addition, the effluent turbidity is also greatly reduced. As the filterability of the mixed liquor is improved, the flux rate of the non-woven membrane 30 is thereafter enhanced. These filterability improvement chemicals may be used to condition the biomass or activated sludge of the MBR system 10 and improve filtering characteristics of sludge substantially. It is believed that adding an effective amount of the filterability improvement chemicals to the mixed liquor or activated sludge of the MBR system 10 greatly improve sludge filterability, thereby reducing the risk to the non-woven membrane 30 associated with handling peak flows, reducing membrane cleaning requirements, and the MBR system 10 can be designed at higher flux rate. Additionally, adding an effective amount of the filterability improvement chemicals improves filtering characteristics of sludge.

In one embodiment, the filterability improvement chemical is an effective amount of a tannin containing polymer added to the mixed liquor of the MBR system 10. Tannin, also called tannic acid, occurs in the leaf, branch, bark and fruit of many plants. The composition and structure of tannin will vary with the source and the method of extraction, but the empirical structure is given as C₇₆H₅₂O₄₆ with many OH groups attached to the aromatic rings. The tannin disclosed in the present invention is a condensed tannin type including but not limited to those derived from Quebracho, Mimosa and Sumac. However, hydrolyzable tannins are also contemplated to be within the scope of this invention.

In one embodiment, the tannin containing polymer is comprised of a water soluble or dispersible copolymer of a tannin and a cationic monomer. In another embodiment, the tannin containing polymer composition comprises a copolymer of tannin, a cationic monomer, and at least one monomer selected from the group consisting of an anionic monomer and a nonionic monomer. In U.S. Pat. No. 5,643,462, assigned to the Assignee of the present invention, the composition of these tannin-based polymers is disclosed. U.S. Pat. No. 5,643,462 is incorporated by reference herein in its entirety. The tannin containing polymers are obtained by polymerizing ethylenically unsaturated monomers with tannin. The resulting tannin copolymer has amphoteric character, through the hydroxyl and carboxyl groups on the tannin backbone and the functionalized cationic moiety due to the dimethylaminoethylacrylate methylchloride.

Cationic polymer means a polymer having an overall positive charge. A cationic polymer is typically prepared by vinyl addition polymerization of one or more cationic monomers, by copolymerization of one or more cationic monomers with one or more nonionic monomers, or by polymerization of the cationic monomers with one or more anionic monomers and optionally one or more nonionic monomers to produce an amphoteric polymer.

The cationic monomer is selected from a group containing ethylenically unsaturated quaternary ammonium, phosphonium or sulfonium ions. Cationic monomers, include, but are not limited to, quaternary ammonium salts of dialkylaminoalkyl(meth)acrylamides, dialkylaminoalkyl(meth)acrylates and diallyl dialkyl ammonium chloride.

In one embodiment of the present invention, the cationic monomer is selected from the group including, but are not limited to, methyl chloride quaternary salt of diethylaminoethyl acrylate, dimethyl sulfate salt of diethylaminoethyl acrylate, dimethylaminoethyl acrylate, dimethylaminoethyl methacrylate, diethylaminoethyl methacrylate, dimethylaminopropyl methacrylamide, dimethylaminopropyl acrylamide, diallyldimethyl ammonium chloride and diallyldiethyl ammonium chloride. In an alternate embodiment, the cationic monomer is methyl chloride quaternary salt of diethylaminoethyl acrylate.

The nonionic monomer is selected from the group of ethylenically unsaturated nonionic monomers which comprise but are not limited to acrylamide, methacrylamide, N-methylolacrylamide, N,N-dimethyl-acrylamide; lower alkyl (C₁-C₆) esters including vinyl acetate, methyl acrylate, ethyl acrylate, and methyl methacrylate; hydroxylated lower alkyl (C₁-C₆) esters including hydroxyethyl acrylate, hydroxypropyl acrylate and hydroxyethyl methacrylate; allyl glycidyl ether; and ethoxylated allyl ethers of polyethylene glycol, polypropylene glycol and propoxylated acrylates. In one embodiment, the nonionic monomer is selected from the group consisting of acrylamide, methacrylamide, N-methylolacrylamide, N,N-dimethylacrylamide, vinyl acetate, methyl acrylate, ethyl acrylate, methyl methacrylate, hydroxyethyl acrylate, hydroxypropyl acrylate, hydroxyethyl methacrylate, allyl glycidyl ether, and ethoxylated allyl ether of polyethylene glycol and polypropylene glycol. In another embodiment, the nonionic monomers are selected from the group consisting of allyl glycidyl ether and acrylamide.

The anionic monomer is selected from the group containing ethylenically unsaturated carboxylic acid or sulfonic acid functional groups. In one embodiment, the anionic monomers include, but are not limited to, acrylic acid, methacrylic acid, vinyl acetic acid, itaconic acid, maleic acid, allylacetic acid, styrene sulfonic acid, 2-acrylamido-2-methyl propane sulfonic acid, and 3-allyloxy-2-hydroxypropane sulfonic acids and salts thereof. In an alternate embodiment, the anionic monomer is acrylic acid.

The MBR system 10 may be further treated by adding an effective amount of one or more other water soluble sludge filterability improvement polymers, or combinations thereof, to the mixed liquor. In an alternate embodiment, the MBR may be further treated by adding an effective amount of sludge filterability improvement inorganic coagulants to the activated sludge.

Other water soluble sludge filterability improvement polymers include, but are not limited to, water soluble polymers such as polyDADMAC (diallyldimethyl ammonium chloride) and polyMETAC ((methacryloyloxy)ethyl trimethylammonium chloride). In an alternate embodiment other water soluble sludge filterability improvement polymers include copolymers of N,N-Dimethylaminoethyl Acrylate Methyl Chloride (AETAC) and acrylamide (AM).

In one embodiment, a method of conditioning mixed liquor in a membrane bioreactor (MBR) system which comprises adding an effective amount of filterability improvement polymers in combination with an effective amount of an inorganic coagulant to the mixed liquor is disclosed. The inorganic coagulant is selected from the group consisting of Ca, Mg, Al, and Fe, and combinations thereof. In an alternate embodiment, the inorganic coagulant is selected from the group consisting of Al and Fe, and combinations thereof. The tannin containing polymers, other types of water soluble sludge filterability improvement polymers, and sludge filterability improvement inorganic coagulants can be added separately or in a combination thereof, to the activated sludge in the MBR system 10.

In one embodiment, the resulting tannin containing polymer contains from 10% to 90% by weight of tannin, 20% to 80% by weight of cationic monomer, 0% to 30% by weight of nonionic monomer, and 0% to 20% by weight of anionic monomer, provided that the resulting tannin containing polymer is still water soluble or dispersible and the total weight % of cationic, nonionic and anionic monomers and tannin adds up to 100%. Preferably, when the cationic monomer and anionic monomer are present together in the tannin containing polymer, the cationic monomer comprises a greater weight percentage than the anionic monomer.

According to one embodiment of the present invention, the copolymer of tannin and cationic monomer contains 20 weight % to 80 weight % of tannin In another embodiment, the copolymer contains from 30 weight % to 60 weight % of tannin, and in an alternate embodiment, from 30 weight % to 50 weight % of the tannin in the copolymer, provided the total weight of tannin and cationic monomer totals 100 weight %. In another embodiment, the copolymers have a weight % of 30% tannin and 70% cationic monomer, and 50% tannin and 50% cationic monomer. In one embodiment, these particular copolymers may be used when the tannin is a Mimosa type tannin and the cationic monomer is methyl chloride quaternary salt of dimethylamino ethyl acrylate.

In one embodiment, the tannin containing polymer has a concentration of tannin of from about 10% to about 90%, or said cationic monomer has a concentration of from about 20% to about 80%. In another embodiment, the tannin containing polymer has a concentration of tannin of from about 40% to about 70%, or said cationic monomer has a concentration of from about 30% to about 60%.

The resulting tannin containing polymer is water soluble or dispersible. The tannin containing polymers may be prepared by mixing the desired monomers with tannin and initiating by a free radical initiator via solution, precipitation or emulsion polymerization techniques. Conventional initiators include, but are not limited to, azo compounds, persulfates, peroxides and redox couples. Additional initiators include, but are not limited to, 2,2′azobis(2-amidinopropane) dihydrochloride (available as V-50 from Wako Chemicals, Richmond, Va.) and t-butylhydroperoxide/sodium metabisulfite (t-BHP/NaMBS). These or other initiators may be added at the end of polymerization to further react with any residual monomers.

Chain transfer agents such as alcohol, amine, formic acid or mercapto compounds may be used to regulate the molecular weight of the polymer. The resulting polymer may be isolated by well-known techniques including precipitation, or the polymer may simply be used in its aqueous solution.

The tannin containing polymer has a low molecular weight, often less than 100,000 Dalton, less than most reported filterability improvement polymers, such as polyamine coagulants. With a lower molecular weight, the tannin containing polymers are less sensitive to overdosing which, once it occurs, may result in reduced biological activity and membrane fouling. In one embodiment of the present invention, the tannin containing polymer has a molecular weight of from about 10,000 Da to about 150,000 Da. In another embodiment, the tannin containing polymer has a molecular weight of from about 50,000 Da to about 90,000 Da.

The filterability improvement chemical should be added to the system to be treated in an amount sufficient for its intended purpose. For the most part, this amount will vary depending upon the particular system for which treatment is desired and can be influenced by such variables as turbidity, pH, temperature, water quantity, MLSS and type of contaminants present in the system. For example, tannin containing polymers are effective at a wide range of pHs and should prove effective at the pH of any system.

The filterability improvement chemical may be added to the system either continuously or intermittently. Desirably, the filterability improvement chemical is not be added directly onto the activated sludge at the membrane surface, but rather is added upstream of the membrane surface to ensure complete mixing with activated sludge. In one embodiment, the filterability improvement chemical is well mixed with the mixed liquor prior to coming into direct contact with the membrane surface. In another embodiment, the mixing is accomplished by feeding the filterability improvement chemical into an area of the bioreactor where an intensive mixing occurs. In an alternate embodiment, the mixing is accomplished by feeding the filterability improvement chemical into an area of the MBR where sufficient mixing time occurs, in proximity to a pump station, an aeration nozzle, or a sludge or mixed liquor recycling pipe.

Other water soluble sludge filterability improvement polymers include, but are not limited to, all water soluble polymers for conditioning the activated sludge for filterability improvement, such as polyDADMAC (diallyldimethyl ammonium chloride) and polyMETAC ((methacryloyloxy)ethyl trimethylammonium chloride). In an alternate embodiment, other water soluble sludge filterability improvement polymers include copolymers of N,N-Dimethylaminoethyl Acrylate Methyl Chloride (AETAC) and acrylamide (AM). These water soluble sludge filterability improvement polymers can be added separately or in combination with the tannin containing polymer or inorganic coagulants to the non-woven membrane bioreactor systems as described herein.

The effective amount of the filterability improvement chemical depends on the filterability of the mixed liquor in the MBR system. The characteristics of the mixed liquor, including mixed liquor suspended solids (MLSS) concentration, viscosity, extracellular polymeric substances (EPS), floc size, and colloidal and soluble organic substances all may affect membrane filterability.

In one embodiment, the effective amount of the tannin containing polymer is from about 5 to about 1000 ppm active polymer in the MBR. In an alternate embodiment, the tannin containing polymer is from about 20 to about 50 percent solids. The tannin containing polymer is a solution polymer containing from about 20 percent to about 50 percent active polymer, while the remainder is water. There are different terms to describe the active polymer percentage in polymer solution, such as percent solids, active polymer, and as actives. For a water soluble polymer, actives refers to the active polymer. Since the tannin polymer contains no oil or surfactant, the polymer solids equals the active polymer.

In one embodiment, the effluent of the MBR system is further passed through nanofiltration, reverse osmosis, electrodialysis, or capacitive deionization system to further improve the quality of the product water.

The invention is illustrated in the following non-limiting examples, which are provided for the purpose of representation, and are not to be construed as limiting the scope of the invention. All parts and percentages in the examples are by weight unless indicated otherwise.

### EXAMPLE 1

The filterability of mixed liquor was evaluated by the Time-to-Filter (TTF) test method. The TTF test method was adapted from Standard Methods (APHA, 1992), Method #2710H. The test consisted of placing a mixed liquor sample in a Buchner funnel with a non-woven fabric membrane 30, applying a vacuum, and measuring the time required to filter 50% of the original mixed liquor sample. The non-woven fabric membrane tested was a polypropylene (PP) non-woven fabric with an average pore size of 0.57 μm and a maximum pore size at 1.52 μm.

In the TTF tests, the non-woven membrane 30 was wetted in ethanol for 2 minutes. The non-woven membrane 30 was cut into a 9 cm square and was fitted in a Buchner funnel and was wet to form a good seal. A vacuum pump with a pressure regulator was used, and the vacuum pressure was adjusted to 51 kPa (15 inch Hg). A 200 ml mixed liquor sample was added to the Buchner funnel, and the time to filter 100 ml, which corresponded to 50% of the initial sample volume, was recorded. Time to filter is expressed in seconds.

Prior to the TTF test, a standard Jar Test was conducted to ensure that the added chemical was mixed well with the mixed liquor samples. A Jar Tester (Phipps & Bird™) with each jar containing 500 ml mixed liquor sample was used. Once the pre-determined amount of chemical was quickly added to the samples, a rapid agitation at 200 rpm proceeded for 30 seconds, and then a slow agitation speed at 50 rpm followed for 15 minutes. A test was also conducted on a control sample, which followed the same Jar Test procedure, but no chemical was added.

The mixed liquor sample was taken from the municipal Wastewater Treatment Plant at GE China Technology Center. The activated sludge sample MLSS concentration was measured to be 6.88 g/L. Table 1 shows the results for the two different water soluble polymers and one alum based coagulant.

TABLE 1
TTF Test of Non-Woven fabric for Mixed Liquor
from Municipal Wastewater Treatment Plant

| | Chemical | | 50%-TTF | Turbidity |
|---|---|---|---|---|
| Chemical | dosage (ppm) | 50%-TTF | reduction | (NTU) |
| Control | 0 | 4238 | / | 1.20 |
| Polymer A | 50 | 495 | 88.3% | 0.838 |
| Polymer A | 100 | 99 | 97.7% | 0.404 |
| Polymer B | 100 | 47 | 98.9% | 0.661 |
| Alum Coagulant | 250 | 78 | 98.2% | 0.856 |

Polymer A is a tannin containing polymer solution with an active content of 38%, polymer B is a polyDADMAC polymer solution containing 19% actives and the alum coagulant water solution contains 50% actives.

The data shows a very significant improvement in the membrane filterability of the mixed liquor sample by adding a filterability improvement chemical. The experiments showed that up to more than a 90% reduction in TTF was achieved by dosing an effective amount of the chemical. In addition to filterability improvement, the chemical dosing also improved the filtrate quality as the turbidity was reduced compared to the control where no chemical was added. Compared to inorganic coagulant, the water soluble polymers were more effective and required lower dosage.

### EXAMPLE 2

### Enlargement of Floc Size by Chemical Addition

With the addition of the chemicals to the mixed liquor, the floc size of the mixed liquor was increased significantly. Table 2 shows the change of floc size after a tannin containing polymer was added.

TABLE 2
Change of floc size with addition of a tannin containing polymer

| | Mean diameter of the | |
|---|---|---|
| Chemical addition | flocs (μm) | S.D (μm) |
| Control -no chemical | 56.9 | 51.5 |
| Polymer A-100 ppm | 69.5 | 75.8 |
| Polymer A-200 ppm | 89.4 | 96.3 |

The increase of floc size led to an increase of the cake porosity built on the membrane surface. As illustrated in Example 1, the non-woven fabric membrane filterability was substantially enhanced by the addition of the filterability improvement chemicals (FIC). The enhancement could be attributed to an increase in cake porosity. During the coagulation and flocculation of microbial flocs by the added FIC, a portion of the soluble SMP and colloidal particles in the bulk phase was also entrapped and become incorporated into the coagulated microbial flocs, which led to greater cake porosity. In addition, with the increase of the microbial flocs, the membrane internal pore plugging by microbial sludge floc particles should also be reduced.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

What is claimed:

1. A method for biological treatment of wastewater comprising:
providing a membrane bioreactor system equipped with a water filtration module comprising a non-woven fabric membrane having a pore size in the range of 0.1 μm to 5.0 μm; and
conditioning the mixed liquor by adding an effective amount of a water soluble sludge filterability improvement chemical to increase its floc size.

2. The method of claim 1 wherein the non-woven fabric membrane has a pore size in the range of 0.2 μm to 3.0 μm.

3. The method of claim 1 wherein the water soluble sludge filterability improvement chemical is selected from a group consisting of a tannin containing polymer, a polyDADMAC (diallyldimethyl ammonium chloride) polymer, a polyMETAC ((methacryloyloxy)ethyl trimethylammonium chloride) polymer, a copolymer of N,N-Dimethylaminoethyl Acrylate Methyl Chloride (AETAC) and acrylamide (AM).

4. The method of claim 1 wherein the filterability improvement chemical is a tannin containing polymer.

5. The method of claim 4 wherein said tannin containing polymer is comprised of a water soluble or dispersible copolymer of a tannin and a cationic monomer selected from the group consisting of methyl chloride or dimethyl sulfate quaternary salt of dimethylaminoethyl acrylate, diethylaminoethyl acrylate, dimethylaminoethyl methacrylate, diethylaminoethyl methacrylate, dimethylaminopropyl methacrylamide, dimethylaminopropyl acrylamide, and diallyl dimethyl ammonium chloride.

6. The method of claim 4 wherein said tannin containing polymer is comprised of a water soluble or dispersible copolymer of a tannin, a cationic monomer selected from the group consisting of methyl chloride or dimethyl sulfate quaternary salt of dimethylaminoethyl acrylate, diethylaminoethyl acrylate, dimethylaminoethyl methacrylate, diethylaminoethyl methacrylate, dimethylaminopropyl methacrylamide, dimethylaminopropyl acrylamide and diallyl dimethyl ammonium chloride and at least one monomer selected from the group consisting of an anionic monomer and a nonionic monomer.

7. The method of claim 6 wherein said nonionic monomer is selected from the group consisting of acrylamide, methacrylamide, N-methylolacrylamide, N,N-dimethylacrylamide, vinyl acetate, methyl acrylate, ethyl acrylate, methyl methacrylate, hydroxyethyl acrylate, hydroxypropyl acrylate, hydroxyethyl methacrylate, allyl glycidyl ether, and ethoxylated allyl ether of polyethylene glycol and polypropylene glycol.

8. The method of claim 6 wherein said anionic monomer is selected from the group consisting of acrylic acid, methacrylic acid, vinyl acetic acid, itaconic acid, maleic acid, allylacetic acid, styrene sulfonic acid, 2-acrylamido-2-methyl propane sulfonic acid, and 3-allyloxy-2-hydroxypropane sulfonic acid.

9. The method of claim 3 wherein the water soluble sludge filterability improvement chemical is mixed with the mixed liquor prior to being in direct contact with the membrane surface.

10. The method of claim 1 where the water soluble sludge filterability improvement chemical is selected from an inorganic coagulant consisting of: Al, Fe, Ca, or Mg, and combinations thereof.

11. The method of claim 1 wherein the effluent quality is suitable for reuse.

12. The method of claim 1 wherein a nanofiltration, reverse osmosis, electrodialysis, or capacitive deionization system is used to further improve the quality of the MBR effluent.
